(19) United States
(12) Patent Application Publication
(10) Pub. No.: US 2015/0277905 A1
(43) Pub. Date: Oct. 1, 2015

(54) ARITHMETIC PROCESSING UNIT AND CONTROL METHOD FOR ARITHMETIC PROCESSING UNIT

(71) Applicant: FUJITSU LIMITED, Kawasaki-shi (JP)

(72) Inventors: Ryohei Okazaki, Kawasaki (JP); YASUNOBU AKIZUKI, Kawasaki (JP); Takekazu Tabata, Kawasaki (JP)

(21) Appl. No.: 14/665,405

(22) Filed: Mar. 23, 2015

(30) Foreign Application Priority Data
Mar. 28, 2014 (JP) 2014-068415

(51) Int. Cl. G06F 9/30

(52) U.S. Cl. CPC G06F 9/3001; G06F 9/30145; G06F 9/3013

(57) ABSTRACT

An arithmetic processing unit includes, an instruction decoder; three or more operators to, when the instruction is a multi-data instruction, process in parallel the plural data, and when the instruction is a non-multi-data instruction, process the singular data individually; storage destination register groups corresponding to the operators to store operation results from the operators; renaming register groups corresponding respectively to the operators to store the operation results; and a register renaming unit to store an association between a specified storage destination register specified by an instruction and an allocated renaming register. A register set having the storage destination register group and the renaming register group includes a basic register set used to operate the multi-data and the non-multi-data instructions, a first extended register set used to operate the multi-data and the non-multi-data instruction, and a second extended register set used to operate the multi-data instruction but not the non-multi-data instruction.

### CROSS-REFERENCE TO RELATED APPLICATION

This application is based upon and claims the benefit of priority of the prior Japanese Patent Application No. 2014-068415, filed on Mar. 28, 2014, the entire contents of which are incorporated herein by reference.

### FIELD

The present invention relates to an arithmetic processing unit and a control method for an arithmetic processing unit.

### BACKGROUND

A CPU (Central Processing Unit) serving as an arithmetic processing unit (an operation processing unit or a processor) employs various processing speed increasing techniques. These processing speed increasing techniques include, for example, a pipeline processing system in which consecutive instructions are divided into a plurality of stages or cycles and processed successively, a superscalar system in which operation processes are executed in parallel, an out-of-order execution system in which instructions are executed as soon as input data, operators, and the like used to execute the instructions are ready instead of executing the instructions in a sequence specified by a program, or in other words executing the instructions in order, and so on.

The out-of-order execution system includes a register renaming technique in which output data obtained when execution of an instruction is complete are stored temporarily in a renaming register, and once instructions that come earlier in the processing sequence are completed, the output data are stored in a destination register specified by the instruction as a register in which to hold operation results.

An SIMD (Single Instruction Multiple Data) processing system, in which a plurality of data are processed in parallel in response to a single instruction, is available as a further technique for increasing processing speed by performing a plurality of processes in parallel. In the case of 4-SIMD, in which four sets of data are processed in parallel in response to a single instruction, the CPU that realizes the SIMD processing system decodes a single instruction code (operation code), reads data (source operand data) respectively from first to fourth source side registers identified by identical addresses, inputs the read data respectively into first to fourth operators (arithmetic logic units), and outputs four obtained operation results (arithmetic operation results) respectively to first to fourth destination side (storage destination) registers.

A CPU in which the out-of-order system and the SIMD processing system are incorporated realizes the out-of-order system by including both a destination register (a storage destination register) specified by an instruction as a register in which final processing results are stored, and a renaming register in which processing results are stored temporarily, and realizes the SIMD processing system by including sets of an operator (an arithmetic logic unit), a destination register, a renaming register, and a register renaming unit that stores associations between the destination registers and the renaming registers in a number of sets that can be processed in parallel by SIMD.

Japanese Laid-open Patent Publication No. 2011-34450 and Japanese Laid-open Patent Publication No. 2007-234011, for example, describe CPUs in which the out-of-order system and the SIMD processing system are incorporated.

### SUMMARY

A CPU in which the out-of-order system and the SIMD processing system are incorporated is preferably able to make effective use of extended operators (arithmetic logic units) and registers provided to process an SIMD instruction (also referred to as a multi-data instruction) for processing a plurality of data sets in response to a single instruction likewise when a non-SIMD instruction (also referred to as a non-multi-data instruction) for processing a single data set for a single instruction is executed. The reason for this is that by making effective use of hardware resources, a larger number of non-SIMD instructions (or non-multi-data instructions) are processed.

However, when an attempt is made to increase a degree of freedom of using hardware resources so that the all of the plurality of sets of operators, destination registers, renaming registers, and register renaming units provided to process an SIMD instruction (or a multi-data instruction) can also be used to process a non-SIMD instruction, a circuit volume of hardware circuits increases. An increase in the circuit volume of the register renaming units storing the associations between the registers is particularly noticeable since there is no need to reference the associations between all of the registers on maps provided in the register renaming units when processing an SIMD instruction (a multi-data instruction).

In other words, by increasing a degree of parallelism of the SIMD processing, processing an application that executes instructions to compute a large amount of data can be increased in speed, but when an attempt is made at the same time to secure a high degree of freedom in the use of hardware resources during processing of non-SIMD instructions (non-multi-data instructions), the hardware circuits increase in scale. Hence, it is desirable to increase the degree of parallelism of the SIMD processing while suppressing the scale of the hardware circuits to a reasonable level.

One aspect of embodiments is an arithmetic processing unit comprising:

an instruction decoder configured to decode an instruction;

three or more operators configured to, when the instruction decoded by the instruction decoder is a multi-data instruction in which plural data processing is implemented parallel in response to a single instruction, process in parallel the plural data, and when the instruction decoded by the instruction decoder is a non-multi-data instruction in which singular data processing is implemented in response to a single instruction, process the singular data individually;

a plurality of storage destination register groups that are provided to correspond respectively to the plurality of operators and are configured to store operation results from the operators;

a plurality of renaming register groups that are provided to correspond respectively to the plurality of operators and are configured to store the operation results; and

a register renaming unit configured to store an association between a specified storage destination register specified by an instruction from the storage destination register group and an allocated renaming register allocated from the renaming register group,

wherein a register set having the storage destination register group and the renaming register group includes a basic register set used to operate the multi-data instruction and to operate the non-multi-data instruction, a first extended register set used to operate the multi-data instruction and to operate the non-multi-data instruction, and a second extended register set used to operate the multi-data instruction but not used to operate the non-multi-data instruction, and

the register renaming unit stores the association of the basic register set and the association of the first extended register set.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view depicting an information processing apparatus installed with an operation processing unit (an arithmetic processing unit) according to an embodiment.

FIG. 2 is a view depicting a configuration of the CPU core (the operation processing unit) according to this embodiment.

FIG. 3 is a view depicting register renaming processing performed in response to a non-SIMD instruction in a 2-SIMD configuration.

FIG. 4 is a view depicting register renaming processing performed in response to an SIMD instruction in a 2-SIMD configuration.

FIG. 5 is a view depicting different register renaming processing performed in response to a non-SIMD instruction in a 2-SIMD configuration.

FIG. 6 is a view depicting different register renaming processing performed in response to an SIMD instruction in a 2-SIMD configuration.

FIG. 7 is a view depicting different register renaming processing performed in response to a non-SIMD instruction in a 3-SIMD configuration.

FIG. 8 is a view depicting different register renaming processing performed in response to an SIMD instruction in a 3-SIMD configuration.

FIG. 9 is a view depicting the configuration of the CPU core according to this embodiment.

FIG. 10 is a view depicting register renaming processing performed in response to a non-SIMD instruction in a 3-SIMD configuration according to a first embodiment.

FIG. 11 is a view depicting register renaming processing performed in response to an SIMD instruction in the 3-SIMD configuration according to the first embodiment.

FIG. 12 is a view depicting register renaming processing performed during execution of an SIMD instruction in a 3-SIMD configuration according to a second embodiment.

FIG. 13 is a view illustrating pipeline processing performed during execution of a floating point SIMD operation instruction, according to this embodiment.

FIG. 14 is a view illustrating pipeline processing performed during execution of a floating point SIMD operation instruction, according to this embodiment.

FIG. 15 is a view illustrating pipeline processing performed during execution of a non-SIMD operation instruction according to this embodiment.

FIG. 16 is a view illustrating pipeline processing performed during execution of a non-SIMD operation instruction according to this embodiment.

### DESCRIPTION OF EMBODIMENTS

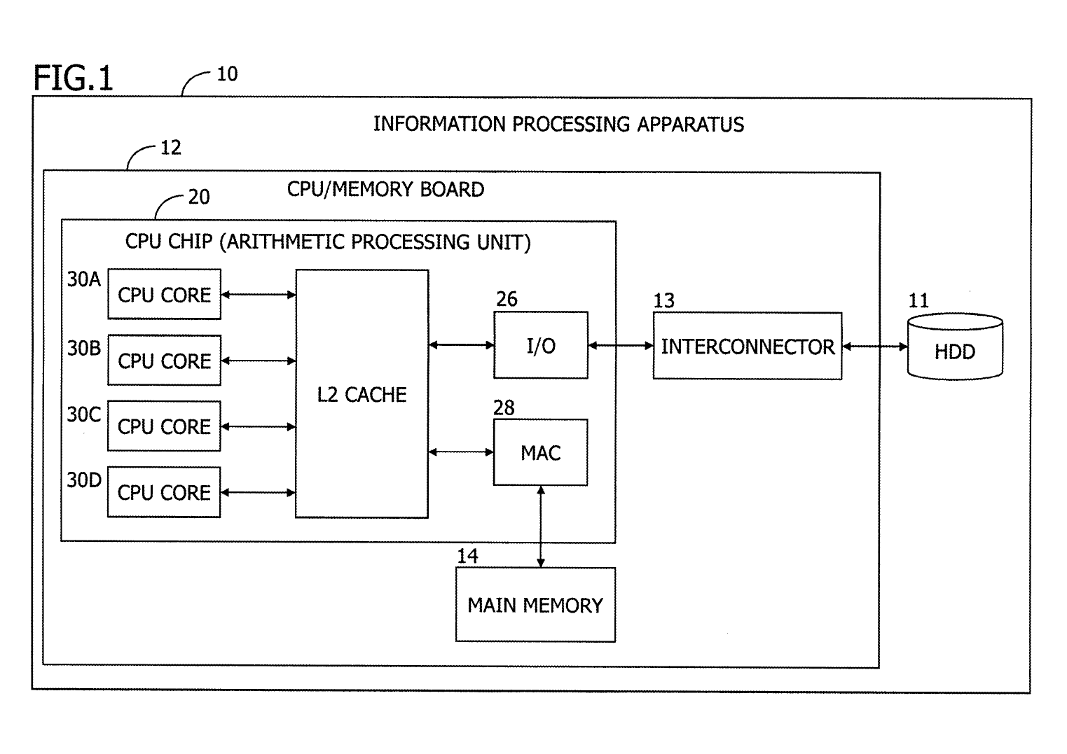

FIG. 1 is a view depicting an information processing apparatus installed with an operation processing unit (an arithmetic processing unit) according to an embodiment. The information processing apparatus 10, which is a computer or the like, includes a CPU/memory board 12, and a hard disk 11 serving as a large capacity storage apparatus. The CPU/memory board 12 includes an operation processing unit (an arithmetic processing unit) 20 constituted by a CPU chip, an interconnector 13 that connects the operation processing unit 20 to the external hard disk 11 and so on, and a main memory 14 such as a DRAM.

The operation processing unit 20 includes, for example, four CPU cores (operation processing units) 30A to 30D, a secondary cache 24 shared by the four CPU cores, an input/output interface 26, and a memory access controller (MAC) 28 that controls access to the main memory 14.

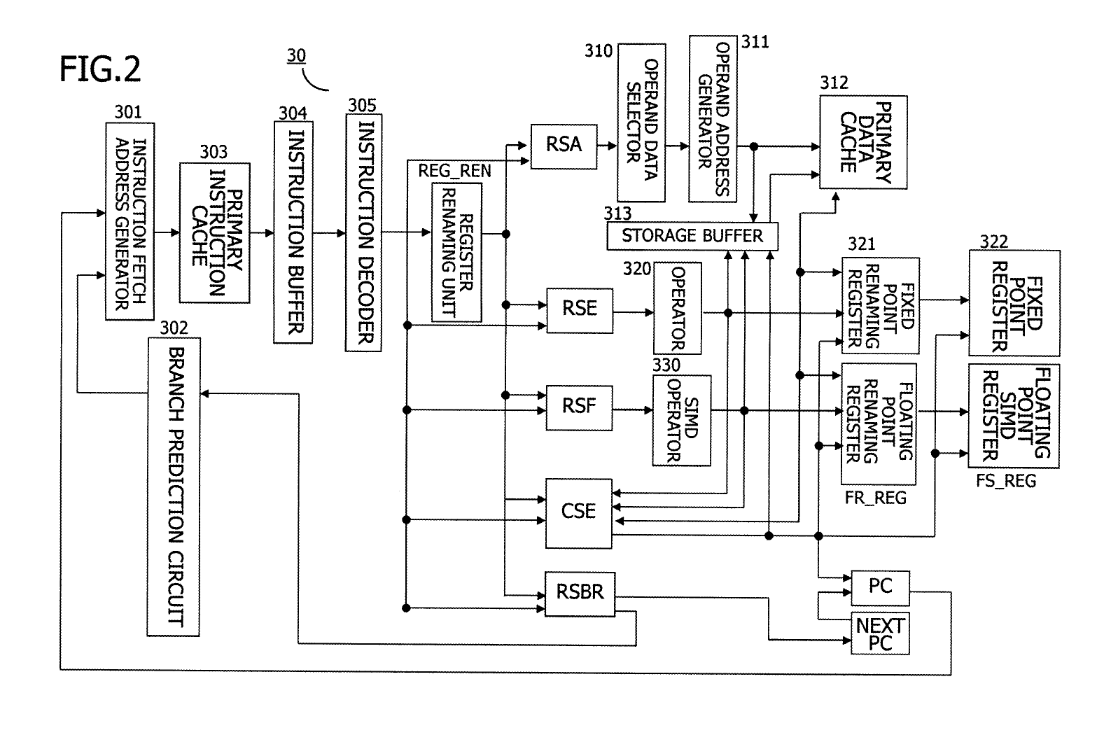

FIG. 2 is a view depicting a configuration of the CPU core (the operation processing unit) according to this embodiment. The CPU core 30 depicted in FIG. 2 has an out-of-order instruction execution function for executing instructions as soon as the instructions are ready to be executed, and a register renaming function for avoiding an execution stall caused by register competition so that instructions executed out of order are completed in program sequence, or in other words in order.

More particularly, the CPU core 30 depicted in FIG. 2 is capable of performing SIMD processing in response to a multi-data instruction (referred to hereafter as an SIMD instruction) to execute a floating point arithmetic operation, floating point loading (reading from memory), or floating point storage (writing to memory) on a plurality of data sets. Needless to mention, the CPU core 30 is also capable of performing processing in response to a non-multi-data instruction (referred to hereafter as a non-SIMD instruction) executed in relation to a single data set.

The CPU core 30 of FIG. 2 includes an instruction fetch address generator 301 that selects a program counter PC or a branch destination address predicted by a branch prediction mechanism, a branch prediction unit 302 that performs branch prediction in relation to a branch instruction, a primary instruction cache 303 that stores instructions, an instruction buffer 304 that temporarily stores an instruction read from the primary instruction cache, and an instruction decoder 305 that decodes the instruction. As will be described below, the instruction decoder 305 generates a control signal corresponding to the instruction, and allocates a renaming register to a storage destination register specified by the instruction.

The CPU core 30 also includes a register renaming unit REG_REN that stores associations between the storage destination registers and the renaming registers allocated thereto, a reservation station (Reservation Station for Address generate: RSA) for generating a main storage operand, a reservation station (Reservation Station for Execute: RSE) for a fixed point arithmetic operation, a reservation station (Reservation Station for Floating: RSF) for a floating point arithmetic operation, a reservation station (Reservation Station for Branch: RSBR) for branching, and a commit stack entry (CSE).

The respective reservation stations RS are queues of instructions issued by the instruction decoder 305, and are provided in association with execution units that execute the instructions. The fixed point arithmetic operation reservation station RSE and the floating point arithmetic operation reservation station RSF in particular issue the instructions to corresponding operators (arithmetic logic units) out of order, or in other words as soon as input data and operators for executing the instructions are ready. The commit stack entry CSE, meanwhile, determines instruction completion in relation to all instruction entries so that an instruction started out of order is completed in order.

The CPU core 30 further includes an operand data selection unit 310, an operand address generator 311, a primary data cache 312, and a storage buffer 313. Furthermore, the CPU core 30 includes an operator (an arithmetic logic unit) 320 that performs a fixed point arithmetic operation, an SIMD operator (an SIMD arithmetic logic unit) 330 that performs a floating point arithmetic operation, a fixed point renaming register 321, a floating point renaming register FR_REG, a fixed point register 322, a floating point SIMD register FS_REG, and the program counter PC.

The instruction fetch address generator 301 selects an instruction address on the basis of a count value of the program counter PC or information from the branch prediction unit 302, and issues an instruction fetch request to the primary instruction cache 303. The branch prediction unit 302 performs branch prediction on the basis of entries in the branch reservation station RSBR. The primary instruction cache 303 stores in the instruction buffer 304 an instruction read in response to the instruction fetch request. Instructions are then supplied from the instruction buffer 304 to the instruction decoder 305 in an instruction sequence specified by a program, or in other words in order, whereupon the instruction decoder 305 decodes the instructions supplied from the instruction buffer 304 in order.

The instruction decoder 305 creates a required entry in one of the four reservation stations RSA, RSE, RSF, and RSBR in accordance with the type of the decoded instruction. The instruction decoder 305 also creates entries corresponding to all of the decoded instructions in the commit stack entry CSE. Further, the instruction decoder 305 allocates a register in a renaming register 321, FR_REG to a register in an architecture register 322, FS_REG specified by the instruction.

When an entry is created in the reservation station RSA, RSE, or RSF, the register renaming unit REG_REN stores the address of the renaming register allocated to the architecture register specified by the instruction. An association between the specified architecture register and the allocated renaming register is registered in a renaming map stored in the register renaming unit REG_REN. The CPU core 30 includes the fixed point register 322 and the floating point SIMD register FS_REG as architecture registers. These registers are specified by the instruction as storage registers in which to store operation processing results. Further, the CPU core includes the fixed point renaming register 321 and the floating point renaming register FR_REG as renaming registers.

When the fixed point register 322 is used as a storage destination register, the instruction decoder 305 allocates the address of the fixed point renaming register 321 as the renaming register. Further, when the floating point SIMD register is used as the storage destination register, the instruction decoder 305 allocates the floating point renaming register FR_REG as the renaming register. The renaming register address allocated to the address of the storage destination register is output to the reservation station RSA, RSE, RSF corresponding to the instruction and the commit stack entry CSE as an association.

The reservation stations RSA, RSE, RSF output the entries held therein as soon as resources required to process the entries, for example data and operators, are ready, whereupon processing corresponding to the entries is executed in later stage blocks such as operators. Accordingly, the instructions are initially executed out of order, and therefore processing results obtained in relation to the instructions are stored temporarily in the fixed point renaming register 321 or the floating point renaming register FR_REG.

Entries corresponding to floating point arithmetic operation instructions, for example, are stored in the floating point reservation station RSF. The SIMD operator 330 selects input data to be computed on the basis of an entry from the reservation station RSF, and executes a floating point arithmetic operation thereon. During execution of the floating point instruction, an operation result from the SIMD operator 330 is stored temporarily in the floating point renaming register FR_REG.

Further, during execution of a floating point storage instruction, the SIMD operator 330 outputs data selected as an operation subject to the storage buffer 313. The storage buffer 313 specifies an operand address output from the operand address generator 311, and writes the data output from the SIMD operator 330 to the primary data cache 312.

The commit stack entry CSE holds entries corresponding to all of the instructions decoded by the instruction decoder 305, and manages execution conditions of the processing corresponding to the respective entries such that the instructions are completed in order. For example, when the commit stack entry CSE determines that the result of the processing corresponding to the entry to be completed next is stored in the fixed point renaming register 321 or the floating point renaming register FR_REG and that the instructions coming earlier in the sequence are completed, the commit stack entry CSE outputs the data stored in the renaming register to the fixed point register 322 or the floating point SIMD register FS_REG. As a result, the instructions executed out of order in the respective reservation stations are completed in order.

The fixed point renaming register 321 and the floating point renaming register FR_REG include a plurality of registers in an identical number to or a smaller number than the number of entries in the commit stack entry CSE.

The SIMD operator 330 includes a basic operator and an extended operator. The basic operator includes an operation circuit that is capable of executing a large number of kinds of operations, for example. The extended operator includes an operation circuit that is capable of handling a part of the operations. In the case of 4-SIMD processing, for example, in which four data sets are processed in parallel by a single instruction, the SIMD operator 330 includes a single basic operator and three extended operators.

The floating point SIMD register FS_REG includes basic registers and extended registers in respectively identical numbers. Likewise, the floating point renaming register FR_REG includes basic renaming registers and extended renaming registers in respectively identical numbers.

In FIG. 2, a fixed point operation unit including the operator 320, the fixed point register 322, and the fixed point renaming register 321 may include a basic operator and an extended operator, a basic register and an extended register, and a basic renaming register and an extended renaming register in order to be capable of handling SIMD processing. In FIG. 2, however, the CPU core 30 is configured to be capable of SIMD processing only with respect to floating point processing.

The floating point reservation station RSF, the SIMD operator 330, the floating point SIMD register FS_REG, and the floating point renaming register FR_REG, which together constitute a floating point operation unit in FIG. 2, process SIMD instructions and non-SIMD instructions as follows. In the case of an SIMD instruction, the basic operator and the extended operator in the SIMD operator 330 perform processing in parallel such that processing results are stored temporarily in the basic register and the extended register of the floating point renaming register FR_REG allocated thereto. When the commit stack entry CSE detects completion of a current instruction and completion of the instructions coming earlier in the sequence, the processing results stored temporarily in the basic register and the extended register of the floating point renaming register FR_REG are stored in the basic register and the extended register of the floating point SIMD register FS_REG.

Likewise in response to a non-SIMD instruction, meanwhile, the processing result from the operator is stored temporarily in the floating point renaming register FR_REG, and when the commit stack entry CSE detects completion of the aforesaid instructions, the processing result stored temporarily in a register of the floating point renaming register FR_REG is stored in a register of the floating point SIMD register FS_REG.

[Problems Involved in Improving Degree of Parallelism in SIMD Processing and Degree of Freedom in Non-SIMD Processing]

Next, problems arising when an attempt is made to improve a degree of parallelism of the SIMD processing and improve a degree of freedom of the non-SIMD processing simultaneously will be described.

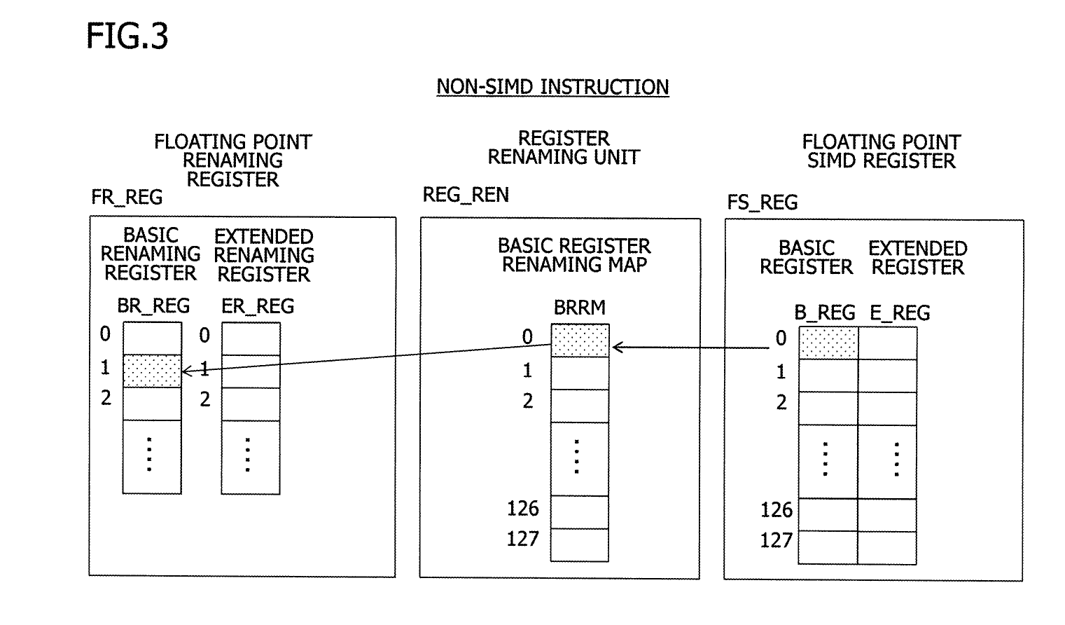

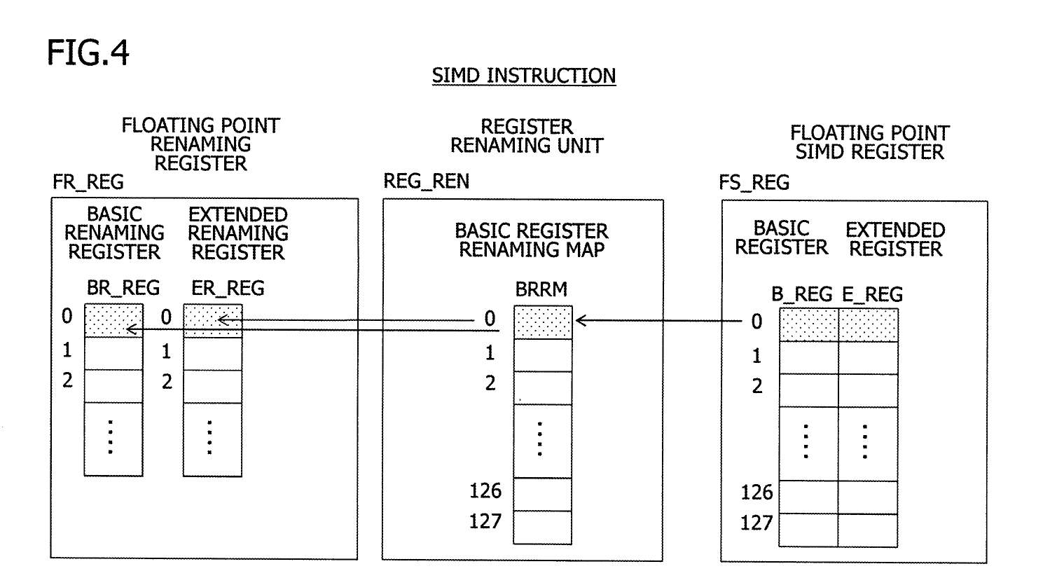

FIG. 3 is a view depicting register renaming processing performed in response to a non-SIMD instruction in a 2-SIMD configuration. FIG. 4 is a view depicting register renaming processing performed in response to an SIMD instruction in a 2-SIMD configuration. As depicted in FIGS. 3 and 4, in a 2-SIMD configuration, the floating point SIMD register FS_REG includes a single group of basic registers B_REG and a single group of extended registers E_REG. The groups of basic registers B_REG and extended registers E_REG respectively have an 8-byte width and include identical numbers of registers. In FIGS. 3 and 4, the groups respectively include 128 registers.

Similarly, the floating point renaming register FR_REG includes a single group of basic renaming registers BR_REG and a single group of extended renaming registers ER_REG. The groups of basic renaming registers BR_REG and extended renaming registers ER_REG respectively have an 8-byte width and include identical numbers of registers. In FIGS. 3 and 4, the groups respectively include no more than 128 registers.

The register renaming unit REG_REN, meanwhile, includes a single basic register renaming map BRRM. The basic register renaming map BRRM includes entries corresponding to register numbers 0 to 127 of the basic registers B_REG in the floating point SIMD register FS_REG, and holds register numbers or addresses of the basic renaming registers BR_REG allocated respectively to the basic registers B_REG. As described above, this basic renaming register allocation processing is performed by the instruction decoder 305.

In the 2-SIMD configuration depicted in FIGS. 3 and 4, a register set consisting of a basic register B_REG in the floating point SIMD register FS_REG and the basic renaming register BR_REG in the floating point renaming register FR_REG allocated thereto is used to execute a non-SIMD instruction. During execution of an SIMD instruction, on the other hand, a register set consisting of a basic register B_REG and an extended register E_REG in the floating point SIMD register FS_REG and the basic renaming register BR_REG and extended renaming register ER_REG in the floating point renaming register FR_REG allocated thereto is used.

The register renaming processing performed during execution of a non-SIMD instruction, depicted in FIG. 3, will now be described. When a non-SIMD instruction is executed, the CPU core executes a single process on a single piece or a single set of 8-byte data. In this case, only the basic registers B_REG are used in the floating point SIMD register FS_REG, and the extended registers E_REG remain unused. For example, the non-SIMD instruction specifies a single register from the group of 128 basic registers B_REG in the floating point SIMD register FS_REG as a destination operand. In this case, the single register in the group of basic registers B_REG in the floating point SIMD register FS_REG is specified as the destination operand by the register number 0 to 127, for example. Meanwhile, the register number or address of the basic renaming register BR_REG allocated to the basic register B_REG specified by the non-SIMD instruction is stored in the basic register renaming map BRRM in the register renaming unit REG_REN. Since the extended registers E_REG of the floating point SIMD register FS_REG are not used during a non-SIMD operation, an extended register renaming map is not needed in the register renaming unit REG_REN, and therefore the extended renaming registers ER_REG are not used.

Next, the register renaming processing performed during execution of an SIMD instruction, depicted in FIG. 4, will be described. When an SIMD operation is executed, a basic register B_REG and an extended register E_REG having identical register numbers, among the register numbers 0 to 127, are used in the floating point SIMD register FS_REG as a set. The basic register B_REG is used by the first of two pieces or sets of 8-byte data processed in parallel in response to the SIMD instruction, while the extended register E_REG having the same register number as the basic register B_REG is used by the second piece or set of data.

Likewise in the floating point renaming register FR_REG, meanwhile, a basic renaming register BR_REG and an extended renaming register ER_REG having identical register numbers, among the register numbers 0 to a certain number, are used as a set. The basic renaming register BR_REG is used by the first of the two pieces or sets of 8-byte data processed in parallel, while the extended renaming register ER_REG having the same register number is used by the second piece or set of data.

In the register renaming unit REG_REN, the allocated register number in the floating point renaming register FR_REG is stored in the basic register renaming map BRRM in the entry that corresponds to the register number specified by the floating point SIMD register FS_REG. The allocated register number does not necessarily have to be identical to the register number of the floating point SIMD register.

In the example depicted in FIG. 4, when the register number “0” of the floating point SIMD register FS_REG is specified as the destination operand by the SIMD instruction, for example, the CPU core executes identical processing in parallel on the two pieces or two sets of 8-byte data specified by the SIMD instruction. Processing result data are then written temporarily to the floating point renaming register FR_REG, and when instructions coming earlier in the sequence are completed so that the current instruction can be completed, the two processing results in the basic and extended renaming registers of the floating point renaming register FR_REG are written to the basic register B_REG and the extended register E_REG having the register number “0”, within the floating point SIMD register FS_REG. As a result, the processing that was started on the instruction out of order is completed in order.

In the register renaming unit REG_REN, meanwhile, the basic renaming register BR_REG and the extended renaming register ER_REG having the same register number “0” or a different register number are allocated to the basic register B_REG and the extended register E_REG having the register number “0”. In the example of FIG. 4, the basic renaming register BR_REG and the extended renaming register ER_REG having the same register number “0” are allocated to the basic register R_REG and the extended register E_REG having the register number “0”.

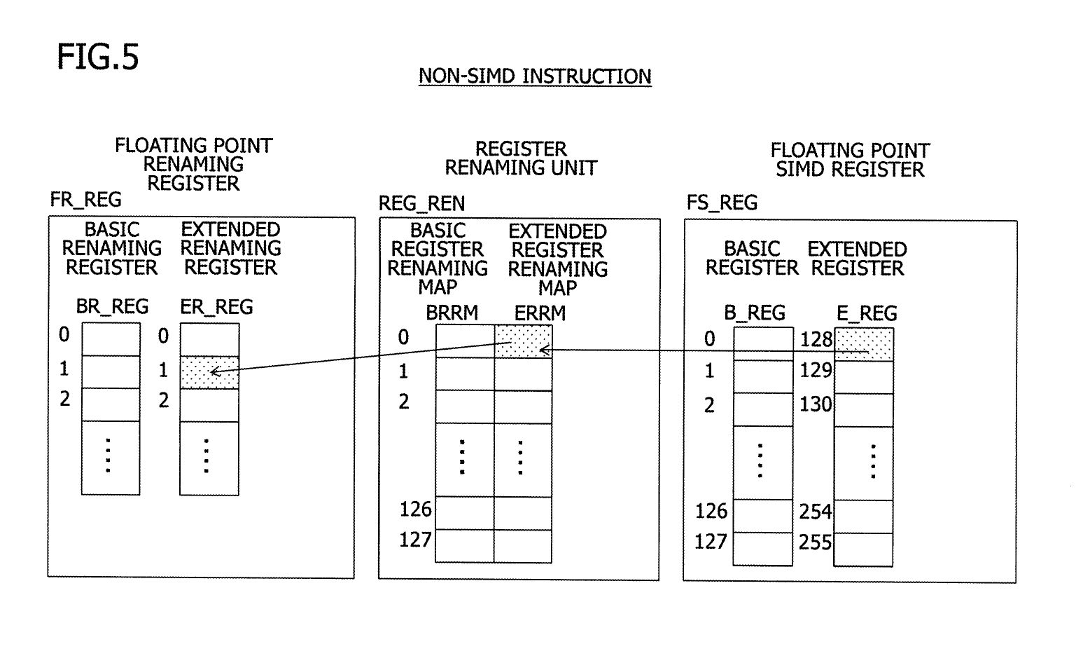

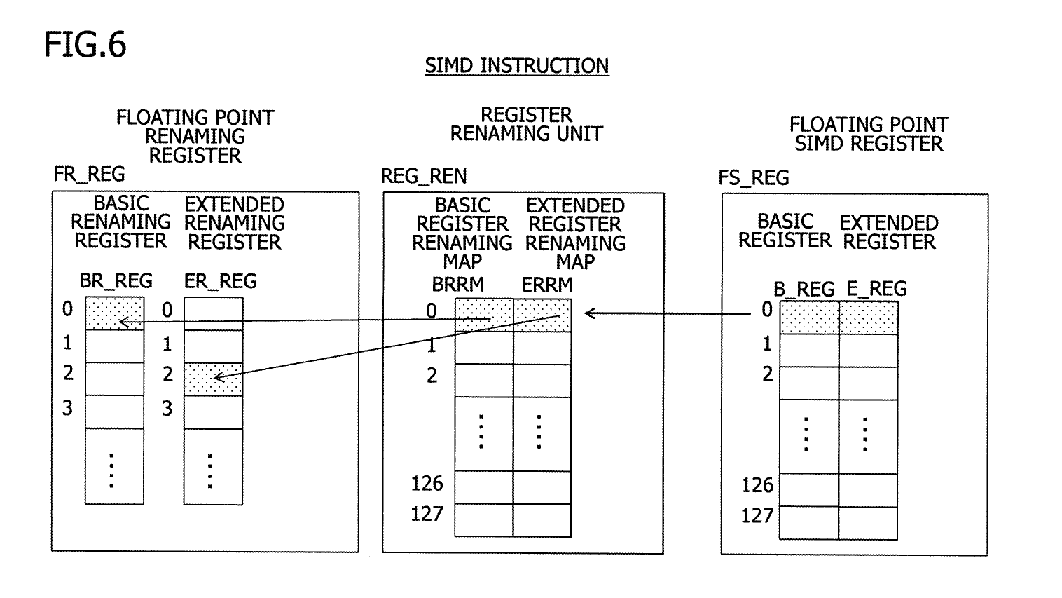

FIG. 5 is a view depicting different register renaming processing performed in response to a non-SIMD instruction in a 2-SIMD configuration. FIG. 6 is a view depicting different register renaming processing performed in response to an SIMD instruction in a 2-SIMD configuration. Configurations depicted in FIGS. 5 and 6 differ from those of FIGS. 3 and 4 as follows. First, in accordance with the 2-SIMD configuration, the floating point SIMD register FS_REG includes a single group of basic registers B_REG and a single group of extended registers E_REG so that when a non-SIMD instruction is executed, a basic register B_REG and an extended register E_REG are specified individually and independently by the non-SIMD instruction. In response, a basic renaming register BR_REG and an extended renaming register ER_REG of the floating point renaming register FR_REG are allocated individually by the instruction decoder. Accordingly, the register renaming unit REG_REN includes a single basic register renaming map BRRM and a single extended register renaming map ERRM.

The basic and extended register renaming maps BRRM, ERRM of the register renaming unit REG_REN include entries corresponding to the basic registers B_REG 0 to 127 and entries corresponding to the extended registers E_REG in the floating point SIMD register FS_REG. The basic register renaming map BRRM holds the register numbers or addresses of the basic renaming registers BR_REG allocated respectively to the basic registers B_REG. Further, the extended register renaming map ERRM holds the register numbers or addresses of the extended renaming registers ER_REG allocated respectively to the extended registers E_REG.

In the 2-SIMD configuration of FIGS. 5 and 6, a register set consisting of a basic register B_REG of the floating point SIMD register FS_REG and the basic renaming register BR_REG of the floating point renaming register FR_REG allocated thereto, or a register set consisting of an extended register E_REG and the extended renaming register ER_REG allocated thereto, is used during execution of a non-SIMD instruction. During execution of an SIMD instruction, on the other hand, a register set consisting of a basic register B_REG and an extended register E_REG of the floating point SIMD register FS_REG and the basic renaming register BR_REG and extended renaming register ER_REG of the floating point renaming register FR_REG, allocated respectively thereto, is used.

The register renaming processing performed during execution of a non-SIMD instruction in FIG. 5 will now be described. When a non-SIMD instruction is executed, the CPU core executes a single process on a single piece of 8-byte data. In this case, the basic registers B_REG and the extended registers E_REG in the floating point SIMD register FS_REG are handled as independent registers, and one of these 256 registers is used for the non-SIMD processing. For example, one of the 256 registers in the floating point SIMD register FS_REG may be specified by the non-SIMD instruction as the destination operand. In this case, the register with number “258” in the floating point SIMD register FS_REG is specified as the destination operand by the register number 0 to 255, for example.

Meanwhile, in the register renaming unit REG_REN, the register number or address of a basic renaming register BR_REG or an extended renaming register ER_REG is allocated to the basic register B_REG or the extended register E_REG specified by the non-SIMD instruction. In the example of FIG. 5, the extended renaming register ER_REG having the register number “1” is allocated to the extended register E_REG having the register number 128.

An extended SIMD operator among the basic SIMD operators and the extended SIMD operators in the floating point SIMD operator 330 is then used and stores the processing result in the extended renaming register ER_REG having the register number “1”. When the processing is complete, the processing result is stored in the extended register E_REG having the register number “128”.

Hence, during execution of a non-SIMD instruction, the extended registers E_REG and the extended renaming registers ER_REG is also used, and as a result, the degree of hardware resource freedom of the non-SIMD instruction is increased.

Next, the register renaming processing performed during execution of a 2-SIMD instruction in FIG. 6 will be described. When an SIMD instruction is executed, a basic register B_REG and an extended register E_REG having identical register numbers, among the register numbers 0 to 127, are used in the floating point SIMD register FS_REG as a set. The basic register B_REG is used by the first of two pieces or two sets of 8-byte data that are processed in parallel in response to the SIMD instruction, while the extended register E_REG having the same register number as the basic register is used by the second piece or set of data.

Likewise in the floating point renaming register FR_REG, meanwhile, the register allocated from the basic renaming registers BR_REG and the register allocated from the extended renaming registers ER_REG are used as a set.

Accordingly, in the basic register renaming map BRRM of the register renaming circuit REG_REN, the register number of the basic renaming register BR_REG allocated to the basic register B_REG is stored in the entry corresponding to the basic register B_REG, and the register number of the extended renaming register ER_REG allocated to the extended register E_REG is stored in the entry corresponding to the extended register E_REG.

For example, when the register number “0” of the floating point SIMD register FS_REG is specified by the SIMD instruction as the destination operand, the CPU core executes identical processing in parallel on the two pieces or two sets of 8-byte data specified by the SIMD instruction. Two sets of processing result data are then written temporarily to the allocated basic and extended renaming registers BR_REG, ER_REG of the floating point renaming register FR_REG, and when the instruction is completed, the processing result data are written to the specified basic register B_REG and extended register E_REG of the floating point SIMD register FS_REG. In this case, in the floating point SIMD register, one piece of processed 8-byte data is stored in the basic register B_REG having the register number “0”, and the other piece of processed 8-byte data is stored in the extended register E_REG having the register number “0”.

In the register renaming unit, meanwhile, a basic renaming register BR_REG and an extended renaming register ER_REG having different register numbers may be allocated respectively to the basic register B_REG and the extended register E_REG having identical register numbers. For example, in the example of FIG. 6, the basic renaming register BR_REG having the register number “0” is allocated to the basic register B_REG having the register number “0”, while the extended renaming register ER_REG having the register number “2” is allocated to the extended register E_REG having the register number “0”.

Therefore, for example, when the register number “0” in the floating point SIMD register FS_REG is specified by the SIMD instruction as the destination operand and renaming register allocation is performed as depicted in FIG. 6, the first piece of processed 8-byte data are stored temporarily in the basic renaming register BR_REG having the register number “0”, while the second piece of processed 8-byte data are stored in the extended renaming register ER_REG having the register number “2”. Then, when the SIMD instruction can be completed on the basis of the instruction sequence, the two pieces of stored data are transferred to the basic register B_REG and the extended register E_REG having the register number “0”. As a result, the SIMD instruction is completed in order.

In the examples depicted in FIGS. 5 and 6, the extended register E_REG and the extended renaming register ER_REG used during execution of an SIMD instruction are used freely likewise during execution of a non-SIMD instruction. As a result, improvements are achieved in both the degree of parallelism of the SIMD instruction and hardware utilization by the non-SIMD instruction.

Hence, a 3-SIMD configuration, in which the degree of parallelism of the SIMD instruction is even further improved, will now be described.

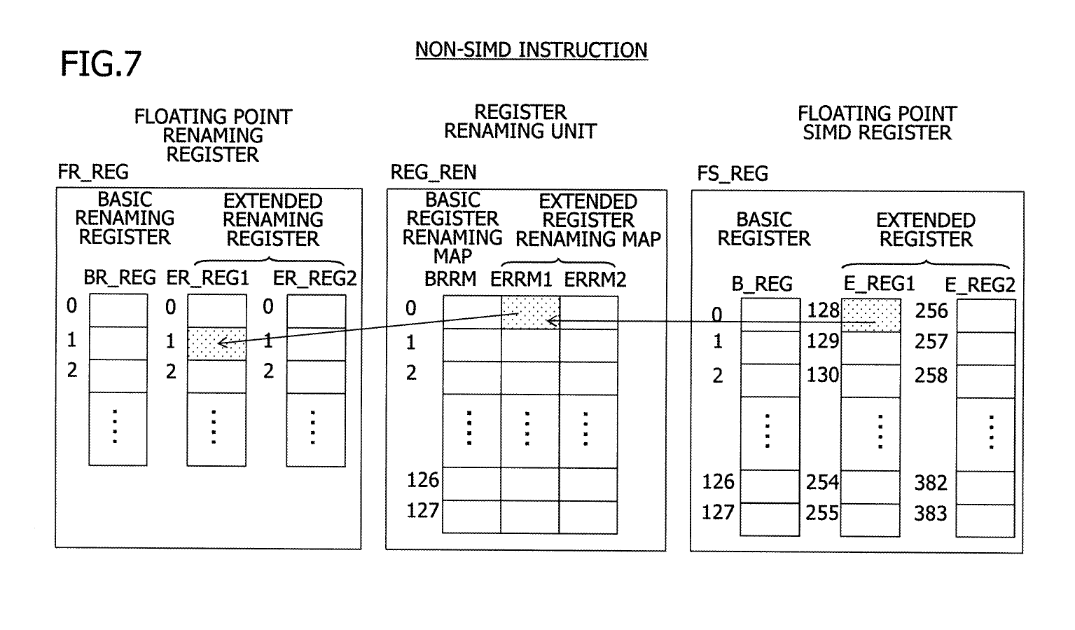

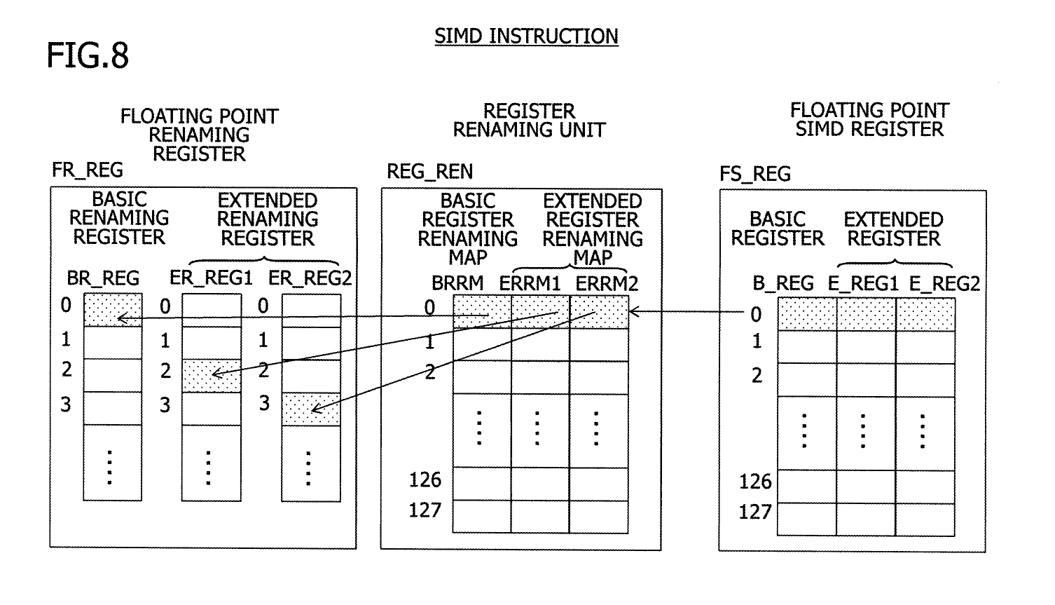

FIG. 7 is a view depicting different register renaming processing performed in response to a non-SIMD instruction in a 3-SIMD configuration. FIG. 8 is a view depicting different register renaming processing performed in response to an SIMD instruction in a 3-SIMD configuration. Configurations depicted in FIGS. 7 and 8 differ from those of FIGS. 5 and 6 as follows. First, in accordance with the 3-SIMD configuration, the floating point SIMD register FS_REG includes a single group of basic registers B_REG and two groups of extended registers E_REG1, E_REG2 so that when a non-SIMD instruction is executed, three registers, namely a basic register B_REG and extended registers E_REG1, E_REG2, are specified individually and independently by the non-SIMD instruction. In response, a basic renaming register BR_REG and two extended renaming registers ER_REG1, ER_REG2 of the floating point renaming register FR_REG are respectively allocated individually by the instruction decoder. Accordingly, the register renaming unit REG_REN includes a single basic register renaming map BRRM and two extended register renaming maps ERRM1, ERRM2.

The basic register renaming map BRRM and the first and second extended register renaming maps ERRM1, ERRM2 of the register renaming unit REG_REN include entries corresponding to the basic registers B_REG having register numbers 0 to 127 and entries corresponding to the first and second extended registers E_REG1, E_REG2 having register numbers 128 to 255 and 256 to 383, respectively, in the floating point SIMD register FS_REG. The basic register renaming map BRRM holds the register numbers or addresses of the basic renaming registers BR_REG allocated respectively to the basic registers B_REG. Further, the two extended register renaming maps ERRM1, ERRM2 hold the register numbers or addresses of the extended renaming registers ER_REG1, ER_REG2 allocated respectively to the extended registers E_REG1, E_REG2.

In the 3-SIMD configuration of FIGS. 7 and 8, a register set including a basic register B_REG of the floating point SIMD register FS_REG and the basic renaming register BR_REG of the floating point renaming register FR_REG allocated thereto, or a register set including a first extended register E_REG1 and the first extended renaming register ER_REG1 allocated thereto, or a register set including a second extended register E_REG2 and the second extended renaming register ER_REG2 allocated thereto, is used during execution of a non-SIMD instruction. During execution of an SIMD instruction, on the other hand, a register set including a basic register B_REG and two extended registers E_REG1, E_REG2 in the floating point SIMD register FS_REG and the basic renaming register BR_REG and the two extended renaming registers ER_REG1, ER_REG2 in the floating point renaming register FR_REG, allocated respectively thereto, is used.

During execution of a non-SIMD instruction in FIG. 7, the non-SIMD instruction specifies a register from the first extended registers E_REG1, and a first extended renaming register ER_REG1 is allocated thereto. Accordingly, the register number “1” of the allocated first extended renaming register ER_REG1 is stored in the first extended register renaming map ERRM1 of the register renaming unit REG_REN in the same entry as the extended register E_REG1.

During execution of an SIMD instruction in FIG. 8, the SIMD instruction specifies a set of the basic register B_REG and the two extended registers E_REG1, E_REG2 having the register number “0” from the floating point SIMD register FS_REG, whereupon the register having the register number “0” among the basic renaming registers BR_REG, the register having the register number “2” among the first extended renaming registers ER_REG1, and the register having the register number “3” among the second extended renaming registers ER_REG2 in the floating point renaming register FR_REG are allocated thereto. Accordingly, the allocated register numbers are stored in the three maps of the register renaming unit REG_REN in the entries having the register number “0”.

When, as depicted in FIGS. 7 and 8, a 3-SIMD configuration is provided in order to improve the degree of freedom with which the non-SIMD instruction uses hardware by making all of the extended registers and extended renaming registers usable by the non-SIMD instruction, while simultaneously improving the degree of parallelism of the SIMD instruction, the circuit scale of the register groups and the register renaming unit REG_REN increases. When a 4-SIMD configuration is provided, the circuit scale increases even further. Depending on the operation program with which the operation processing unit constituted by a CPU chip performs the processing, a high degree of parallelism may be required in relation to the SIMD instruction, but the number of non-SIMD instructions may be small, and in this case, there may not be a great need for a high degree of freedom in the use of hardware by the non-SIMD instruction.

It is therefore preferable to realize improvements in the degree of parallelism of the SIMD instruction and the degree of freedom with which hardware is used by the non-SIMD instruction while suppressing the circuit scale to a reasonable level.

### EMBODIMENT

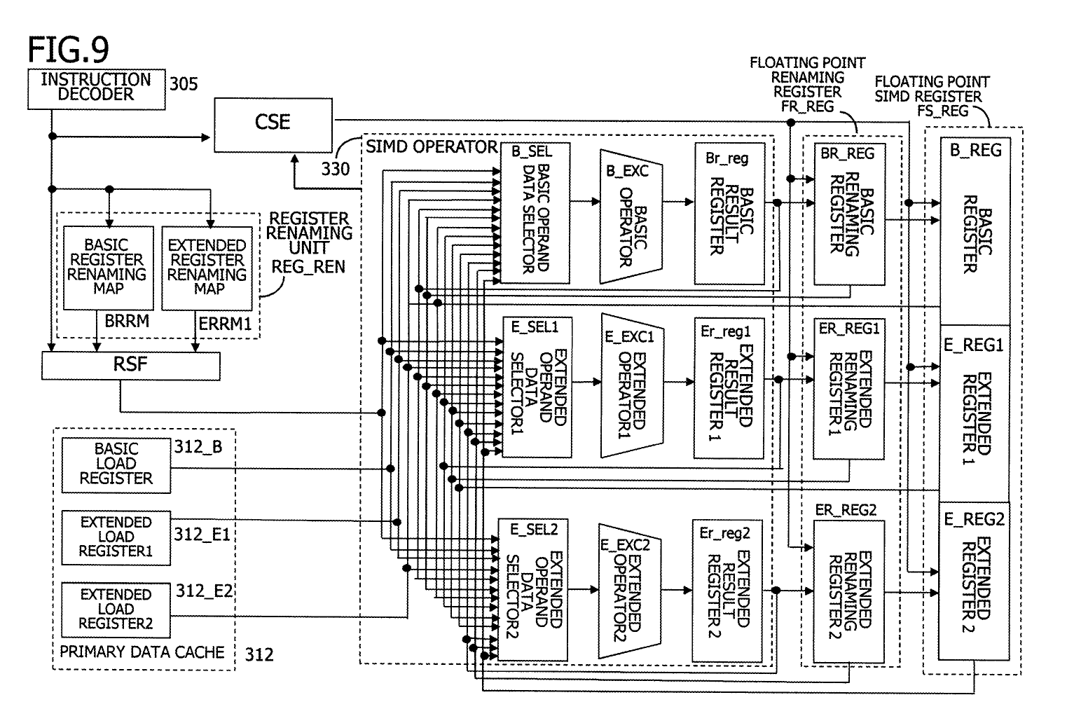

FIG. 9 is a view depicting the configuration of the CPU core according to this embodiment. FIG. 9 depicts in detail the respective configurations of the register renaming unit REG_REN, the primary data cache 312, the SIMD operator 330, the floating point renaming register FR_REG, and the floating point SIMD register FS_REG in the CPU core 30 of FIG. 2.

The CPU core depicted in FIG. 9 has a 3-SIMD configuration with respect to a floating point arithmetic operation. In other words, the SIMD operator 330 includes a single basic operator (arithmetic logic unit) B_EXC and two extended operators (arithmetic logic units) E_EXC1, E_EXC2 so as to be capable of executing a 3-SIMD instruction. A basic operand data selector B_SEL that selects a register in which to store input data and a basic result register Br_reg that stores an operation result are provided respectively on an input side and an output side of the basic operator B_EXC. Extended operand data selectors E_SEL1, E_SEL2 and extended result registers Er_reg1, Er_reg2 are likewise provided in relation to the two extended operators E_EXC1, E_EXC2.

In accordance with the three operators, the floating point renaming register FR_REG includes a single basic renaming register BR_REG and two extended renaming registers ER_REG1, ER_REG2. Similarly, the floating point SIMD register FS_REG serving as the architecture register includes a single basic register B_REG and two extended registers E_REG1, E_REG2.

Further, the primary data cache 312 includes, in addition to a cache memory and a cache control unit not depicted in the drawing, a single basic load register 312_B and two extended load registers 312_E1, 312_E2 for storing data loaded from the cache memory.

Input data input into the operator is selected from the data stored in any of the total of twelve registers including the three load registers in the primary data cache 312, the three basic result registers, the three floating point renaming registers, and the three floating point SIMD registers. Accordingly, the basic operand data selector B_SEL and the two extended operand data selectors E_SEL1, E_SEL2 select one of the twelve registers. When a number of pieces of data that is input into the operator is N, N selectors are provided in each operator.

Although the CPU core 30 in FIG. 9 has a 3-SIMD configuration, the register renaming unit REG_REN includes a single basic register renaming map BRRM and a single extended register renaming map ERRM1. The basic register renaming map BRRM stores a first association between the address or register number of the basic register B_REG specified by the instruction and the address or register number of the basic renaming register BR_REG allocated to the basic register, while the extended register renaming map ERRM1 stores a second association between the address or register number of the first extended register E_REG1 specified by the instruction and the address or register number of the first extended renaming register ER_REG1 allocated to the first extended register.

Meanwhile, the instruction decoder 305 allocates the renaming register such that a third association between the address or register number of the second extended register E_REG2 and the address or register number of the second extended renaming register ER_REG2 allocated to the second extended register is the same as either the first association stored in the basic register renaming map BRRM or the second association stored in the extended register renaming map ERRM1. Hence, the floating point reservation station RSF obtains the address or register number of the register in the second extended renaming register ER_REG2 where the operation result obtained by the second extended operator E_EXC2 is temporarily stored, by referring to either the basic register renaming map BRRM or the extended register renaming map ERRM1.

To execute a 3-SIMD instruction, the CPU core of FIG. 9 uses the single basic operator B_EXC and the two extended operators E_EXC1, E_EXC2, the single basic renaming register BR_REG and the two extended renaming registers ER_REG1, ER_REG2, and the single basic register B_REG and the two extended registers E_REG1, E_REG2.

To execute a non-SIMD instruction, on the other hand, the CPU core uses either the basic operator E_EXC or the first extended operator E_EXC1, either the basic renaming register BR_REG or the first extended renaming register ER_REG1, and either the basic register B_REG or the first extended register E_REG1. Hence, when a non-SIMD instruction is executed, the first extended renaming register ER_REG1 is used in addition to the basic renaming register BR_REG so that execution of the instruction is started out of order, and as a result, the degree of freedom of hardware use is improved.

Note, however, that when a non-SIMD instruction is executed, the second extended renaming register ER_REG2 is not be used. Because of this restriction, only the single extended register renaming map ERRM1 need be provided in the register renaming unit REG_REN in addition to the basic register renaming map BRRM. The number of renaming maps is therefore reduced, and as a result, an increase in the circuit scale is suppressed.

In this embodiment, as described above, the first extended renaming register ER_REG1 is used as a register for temporarily storing operation results during an SIMD instruction operation and a non-SIMD instruction operation, while the second extended renaming register ER_REG2 is used as a register for temporarily storing operation results during an SIMD instruction operation but not used as such a register during a non-SIMD instruction operation.

In other words, the CPU core according to this embodiment includes, as register sets for storing operation results, that are the floating point SIMD register FS_REG and the floating point renaming register FR_REG, a basic register set used during both an SIMD instruction operation and a non-SIMD instruction operation, a first extended register set used during both an SIMD instruction operation and a non-SIMD instruction operation, and a second extended register set used during an SIMD instruction operation but not used during a non-SIMD instruction operation.

Note that the register sets of the floating point SIMD register and the floating point renaming register are used as a register set including a basic register B_REG and a basic renaming register BR_REG, a register set including a first extended register E_REG1 and a first extended renaming register ER_REG1, and a register set including a second extended register E_REG2 and a second extended renaming register ER_REG2.

### First Embodiment

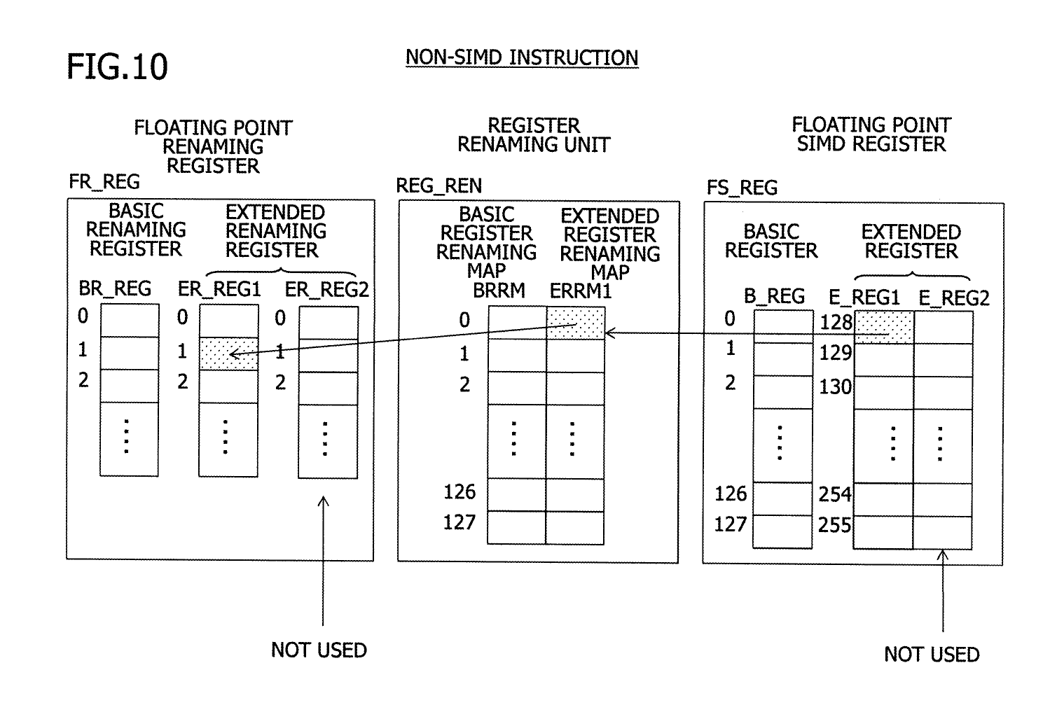

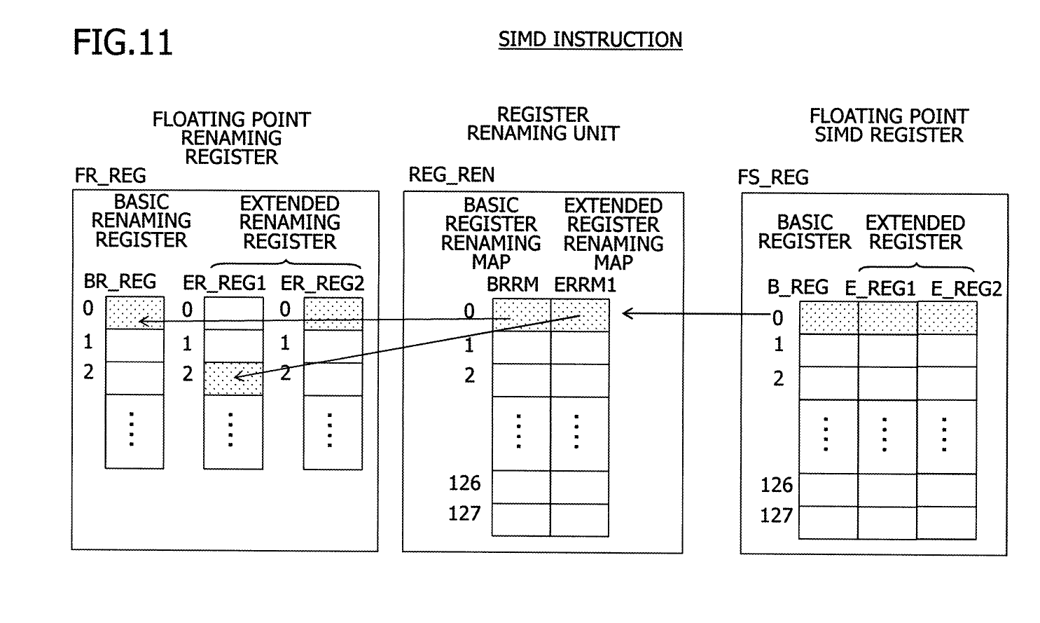

FIG. 10 is a view depicting register renaming processing performed in response to a non-SIMD instruction in a 3-SIMD configuration according to a first embodiment. FIG. 11 is a view depicting register renaming processing performed in response to an SIMD instruction in the 3-SIMD configuration according to the first embodiment.

In FIGS. 10 and 11, similarly to FIG. 9, the floating point SIMD register FS_REG includes a single group of basic registers B_REG and two groups of extended registers E_REG1, E_REG2, wherein each register group includes 128 registers. Accordingly, the floating point renaming register FR_REG includes a single group of basic renaming registers BR_REG and two groups of extended renaming registers ER_REG1, ER_REG2, wherein each register group includes a number of registers equal to or smaller than the number of possible entries in the commit stack entry CSE. The register renaming unit REG_REN includes a single basic register renaming map BRRM and a single extended register renaming map ERRM1.

Register renaming processing performed during execution of a non-SIMD instruction in FIG. 10 will now be described. When a non-SIMD instruction is executed, the CPU core executes a single process on a single piece or a single set of 8-byte data. In this case, the basic registers B_REG and the first extended registers E_REG1 of the floating point SIMD register FS_REG are handled as independent registers, and one of these 256 registers is used in the non-SIMD processing. Note, however, that the second extended registers E_REG2 of the floating point SIMD register FS_REG are not used. In other words, the 128 registers constituting the second extended registers E_REG2, from among the 384 registers in the floating point SIMD register FS_REG, are not used as destination operands during execution of a non-SIMD instruction, and instead, a single register is selected from the 256 registers constituting the basic registers B_REG and the first extended registers E_REG1 and is used in the non-SIMD processing. In this case, for example, a register number between 0 and 255 is specified by the instruction from the 256 registers in the floating point SIMD register FS_REG as the destination operand, or in other words the storage register in which to store the operation result.

Meanwhile, the register renaming unit REG_REN stores the register number or address of the basic renaming register BR_REG or the first extended renaming register ER_REG1 allocated to the basic register B_REG or first extended register E_REG1 of the floating point SIMD register FS_REG that is specified by the non-SIMD instruction.

In the example of FIG. 10, the first extended renaming register ER_REG1 having the register number “1” is allocated to the first extended register E_REG1 having the register number “128”. The second extended registers E_REG2 are not used during a non-SIMD operation, and therefore a second extended register renaming map is not needed. Hence, the register renaming circuit REG_REN does not include a second extended register renaming map.

Register renaming processing performed during execution of an SIMD instruction in FIG. 11 will now be described. When an SIMD instruction is executed, the CPU core performs a single identical process on three pieces or three sets of 8-byte data. In this case, a basic register B_REG, a first extended register E_REG1, and a second extended register E_REG2 having identical register numbers between 0 and 127 are used in the floating point SIMD register FS_REG as a set. The basic register B_REG is used by the first pieces or set of data of the three pieces or three sets of 8-byte data that are processed in parallel in response to the SIMD instruction, while the first extended register E_REG1 and the second extended register E_REG2 having the same register number as the basic register are used by the second and third pieces or sets of data.

As depicted in FIG. 11, when the register number “0” of the floating point SIMD register FS_REG is specified as the destination operand by the SIMD instruction, operation units of the three operators B_EXC, E_EXC1, E_EXC2 in the CPU core execute identical processing in parallel on the three pieces or three sets of 8-byte data specified by the SIMD instruction. Processing result data are then written temporarily to the floating point renaming register FR_REG, and when the instruction is ready to be completed, the processing result data are written to the floating point SIMD register FS_REG. In this case, in the floating point SIMD register FS_REG, the first piece of processed 8-byte data is stored in the basic register B_REG having the register number “0”, while the second and third pieces of processed 8-byte data are stored respectively in the first extended register E_REG1 and the second extended register E_REG2 having the register number “0”.

In the register renaming circuit REG_REN, meanwhile, a basic renaming register BR_REG and a first extended renaming register ER_REG1 having different register numbers are allocated respectively to the basic register B_REG and the first extended register E_REG1 having identical register numbers. Note, however, that the second extended renaming register ER_REG2 having the same number as the basic renaming register BR_REG is allocated to the second extended register ER_REG2. It is therefore not possible to allocate a basic renaming register BR_REG and a second extended renaming register ER_REG2 having different register numbers.

In the example of FIG. 11, the basic renaming register BR_REG having the register number “0” is allocated to the basic register B_REG having the register number “0”, and the first extended renaming register ER_REG1 having the register number “2” is allocated to the first extended register E_REG1 having the register number “0”. The second extended renaming register ER_REG2 having the same register number “0” as the basic renaming register BR_REG is allocated to the second extended register ER_REG2.

Hence, in a case where a register having the register number “0” in the floating point SIMD register FS_REG is specified by the SIMD instruction as the destination operand and three renaming registers BR_REG, ER_REG1, ER_REG2 in the floating point renaming register FR_REG are allocated, as depicted in FIG. 11, processing is performed as follows. The first processed piece of 8-byte data is stored temporarily in the basic renaming register BR_REG having the register number “0”, the second piece of data is stored in the first extended renaming register ER_REG1 having the register number “2”, and the third piece of data is stored in the second extended renaming register ER_REG2 having the register number “0”. When on the basis of the instruction sequence, the SIMD instruction currently being executed is ready to be completed, the data stored respectively in the three renaming registers are transferred to the basic register B_REG, the first extended register E_REG1, and the second extended register E_REG2 having the register number “0”. As a result, the SIMD instruction is completed in order.

### Second Embodiment

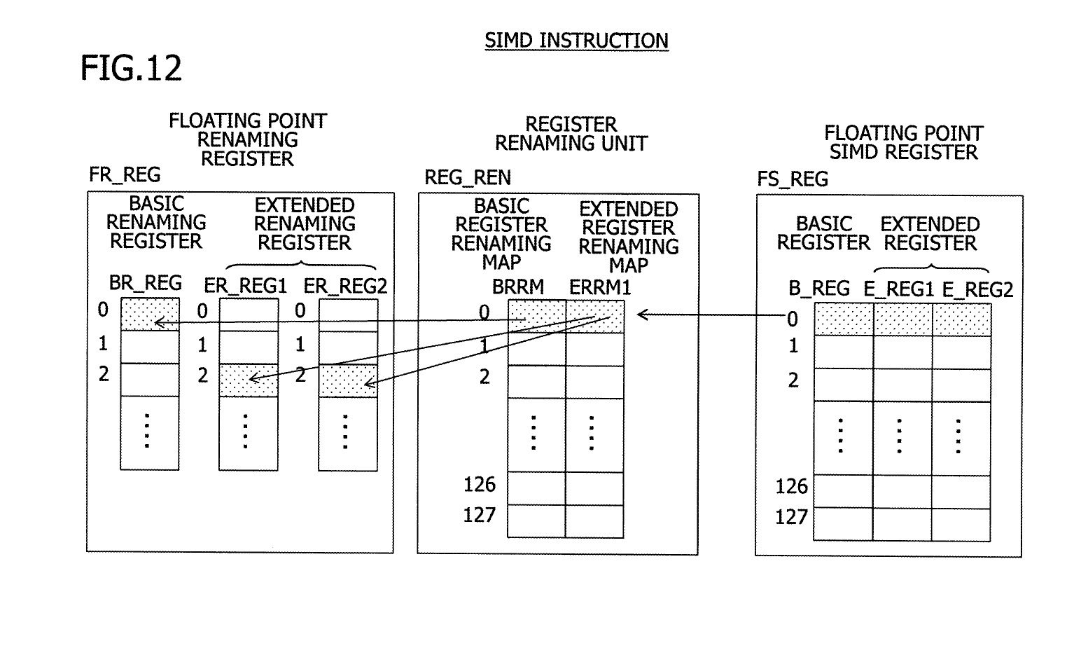

FIG. 12 is a view depicting register renaming processing performed during execution of an SIMD instruction in a 3-SIMD configuration according to a second embodiment. In the second embodiment, a basic renaming register BR_REG and a first extended renaming register ER_REG1 having different register numbers may be allocated respectively to a basic register B_REG and a first extended register E_REG1 having identical register numbers in the renaming maps of the register renaming unit REG_REN. Meanwhile, a second extended renaming register ER_REG2 having an identical number to the first extended renaming register ER_REG1 is allocated to the second extended register E_REG2. Hence, the first embodiment depicted in FIG. 11 differs from the second embodiment in that in the first embodiment, a second extended renaming register ER_REG2 having an identical number to the basic renaming register BR_REG is allocated to the second extended register E_REG2.

In the example of FIG. 12, the register number “0” in the floating point SIMD register FS_REG is specified by the SIMD instruction as the destination operand, and therefore the instruction decoder allocates the basic renaming register BR_REG having the register number “0” to the basic register B_REG having the register number “0”, and allocates the first extended renaming register ER_REG1 and the second extended renaming register ER_REG2 having the same register number “2” respectively to the first extended register E_REG1 and the second extended register E_REG2.

The register renaming processing performed during execution of an SIMD instruction depicted in FIG. 12 is similar to the first processing performed during execution of an SIMD instruction depicted in FIG. 11.

[Operations of CPU Core According to this Embodiment]

Next, operations of the CPU core during execution of a floating point arithmetic operation instruction will be described specifically. An example of operations performed in relation to a floating point arithmetic operation instruction will be described below as an example, but similar register renaming processing is performed in relation to a floating point load instruction and a floating point store instruction.

When the instruction decoder 305 decodes the floating point arithmetic operation instruction, the CPU core reads data from a register specified by a source operand, executes the operation instruction, and writes the operation result to the register specified by the destination operand.

In the case of a floating point arithmetic operation instruction, for example, it is assumed that a following instruction requiring six cycles to execute the operation is executed. An instruction code of a floating point SIMD instruction (referred to hereafter as an SIMD operation instruction) is described as follows, for example.

Simd−fmad % f127×% f100+% f50=% f10

In this instruction, three registers, namely % f127, % f100, and % f50, are specified as the source operands. Three pieces of 8-byte data are read from the specified registers, whereupon three-system multiplication and addition processing are executed thereon in parallel. In other words, three sets of data respectively including three pieces of data are read, whereupon the three sets of data are processed in parallel by operators of three systems. Respective operation results are then written to the floating point SIMD register FS_REG specified by % f10 serving as the destination operand.

An instruction code of a floating point non-SIMD instruction (referred to hereafter as a non-SIMD operation instruction), meanwhile, is described in an identical format to that described above, albeit with a different operation code. In response to this instruction, a single-system operation is performed on each of the registers specified by the source operand, whereupon an operation result is written to the register specified from the floating point SIMD register as the destination operand.

In the SIMD operation instruction of FIG. 11 or FIG. 12, any register number from 0 to 127 is specified as the destination operand. In the non-SIMD operation instruction of FIG. 10, on the other hand, any register number from 0 to 255 is specified as the destination operand.

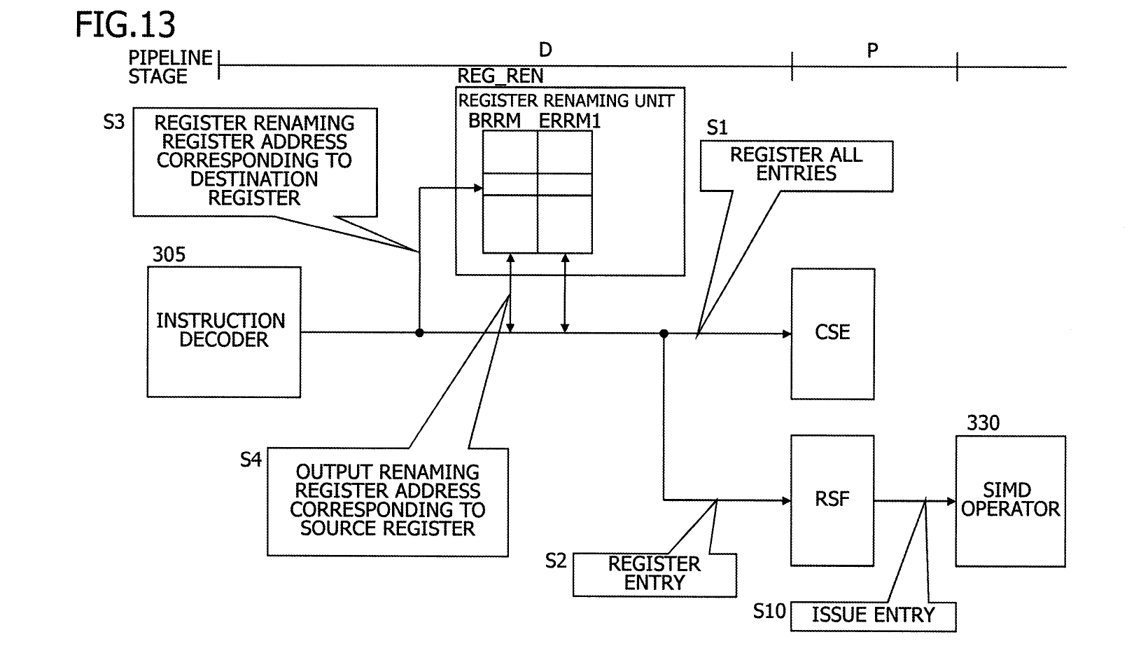

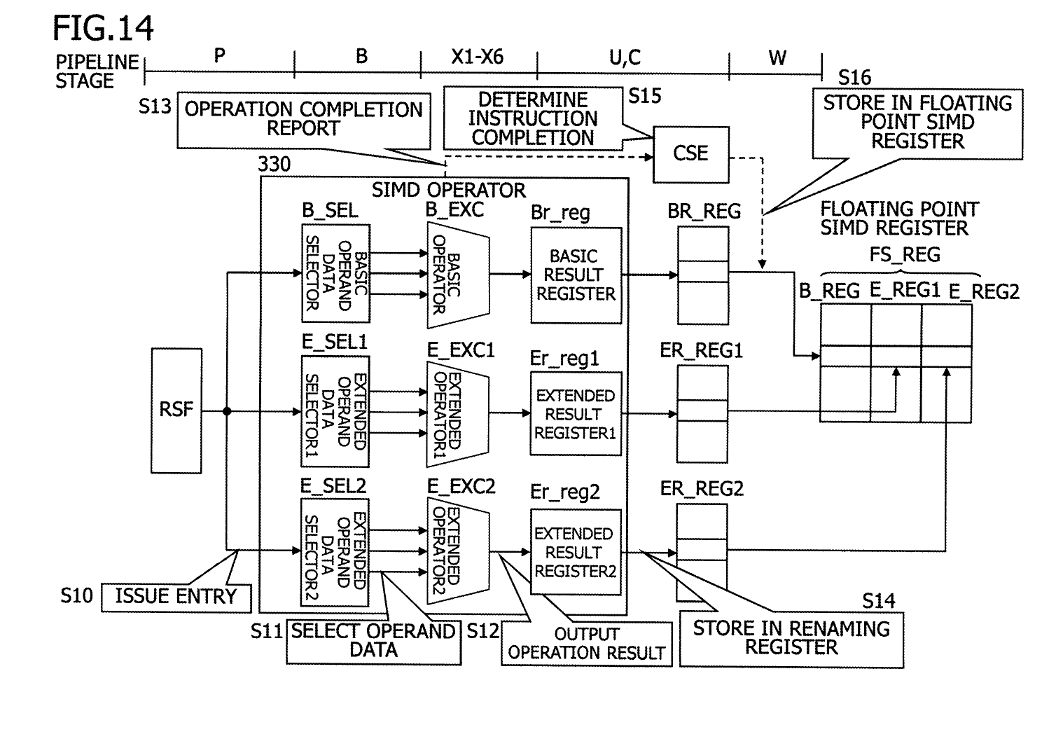

FIGS. 13 and 14 are views illustrating pipeline processing performed during execution of a floating point SIMD operation instruction, according to this embodiment.

A D cycle is an instruction decoding cycle. In the D cycle, the instruction decoder 305 decodes the floating point SIMD instruction, and on the basis of the decoding result registers corresponding entries respectively in the commit stack entry CSE and the floating point reservation station RSF (S1, S2). Entries corresponding to all instructions other than the floating point SIMD operation instruction are registered in the commit stack entry CSE. Further, an entry corresponding to a floating point instruction is registered in the floating point reservation station RSF.

The instruction decoder 305 mainly registers information relating to the write destinations of the operation results in the entries of the commit stack entry CSE. Further, the instruction decoder 305 allocates three registers in the floating point renaming register FR_REG to the three write destination registers in the floating point SIMD register FS_REG, and registers the associations between the three registers in the basic register renaming map BRRM and the extended register renaming map ERRM1 of the register renaming unit REG_REN (S3). More specifically, the instruction decoder 305 writes the register numbers or addresses of the allocated basic renaming register BR_REG and the first extended renaming register ER_REG1 in entries of the two maps BRRM, ERRM1 corresponding to the register numbers specified as the write destinations in the floating point SIMD register FS_REG. The instruction decoder 305 then registers the register numbers or addresses of the registered renaming registers in the entries of the commit stack entry CSE (S4).

Further, the instruction decoder 305 registers information relating to source data of the source operand in an entry of the floating point reservation station RSF. When an address of the source data of the source operand is a register in the floating point SIMD register FS_REG, for example, and data stored temporarily in the floating point renaming register allocated to the register are to be input and computed, the instruction decoder 305 obtains the address of the floating point renaming register by referring to the map in the register renaming unit, and registers the address in an entry in the RSF (S4)

A P cycle is a priority cycle. In the P cycle, the floating point reservation station RSF performs queuing control on the data in the registered entries. The RSF issues the oldest entry, from among the registered entries for which the required input data are ready, to the SIMD operator 330 (S10). Next, the processing advances to FIG. 14.

A following B cycle is a buffer cycle. In the B cycle, the basic operand data selector B_SEL and the first and second extended operand data selectors E_SEL1, E_SEL2 select source operand data from any of the load registers 312_B, 312_E1, 312_E2, the result registers Br_reg, Er_reg1, Er_reg2, the renaming registers BR_REG, ER_REG1, ER_REG2, and the registers B_REG, E_REG1, E_REG2, and input the selected data into the corresponding operator B_EXC, E_EXC1, E_EXC2 (S11). When the input is an execution result relating to an instruction that has completed the load processing or the operation by the operator but has not yet undergone the completion processing by the CSE, the input data are input from the load registers, the result registers, or the renaming registers. Further, a processing result relating to an instruction that has completed execution is input from the registers B_REG, E_REG1, E_REG2.

X1 to X6 denote six operation execution cycles. In the X1 to X6 cycles, the basic operator B_EXC and the first and second extended operators E_EXC1, E_EXC2 execute operation processing on the input data selected by the operand data selectors. The respective operators then store operation results in the respective result registers Br_reg, Er_reg1, Er_reg2 (S12). Further, when having stored the operation results in the result registers, the respective operators output an operation completion report to the commit stack entry CSE (S13).

A U cycle is an update cycle. In the U cycle, the operation results stored in the result registers are stored in the corresponding renaming registers BR_REG, ER_REG1, ER_REG2 (S14).

A C cycle is an instruction completion cycle. In the C cycle, the commit stack entry CSE determines that the SIMD operation instruction is complete on the basis of an operation report from the floating point SIMD operator 330 (S15).

Finally, a W cycle is a register update cycle. The commit stack entry CSE stores the operation results of the renaming registers BR_REG, ER_REG1, ER_REG2 in the three registers B_REG, E_REG1, E_REG2 of the floating point SIMD register FS_REG at a timing when the current SIMD operation instruction is ready to be completed on the basis of the instruction sequence (S16). The commit stack entry CSE then provides the renaming registers with information indicating the registers of the floating point SIMD register FS_REG in which the respective operation results in the registers of the renaming registers should be stored.

As described above, when a floating point SIMD operation instruction is executed, the three registers B_REG, E_REG1, E_REG2 of the floating point SIMD register FS_REG and the three renaming registers BR_REG, ER_REG1, ER_REG2 of the floating point renaming register FR_REG allocated thereto are used.

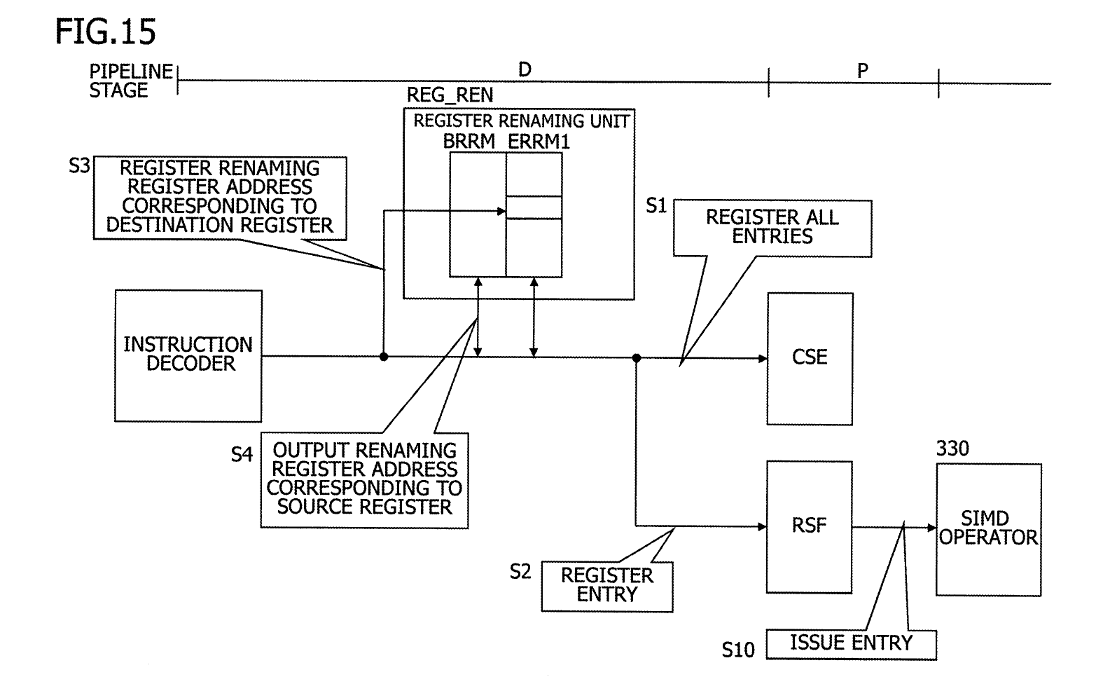

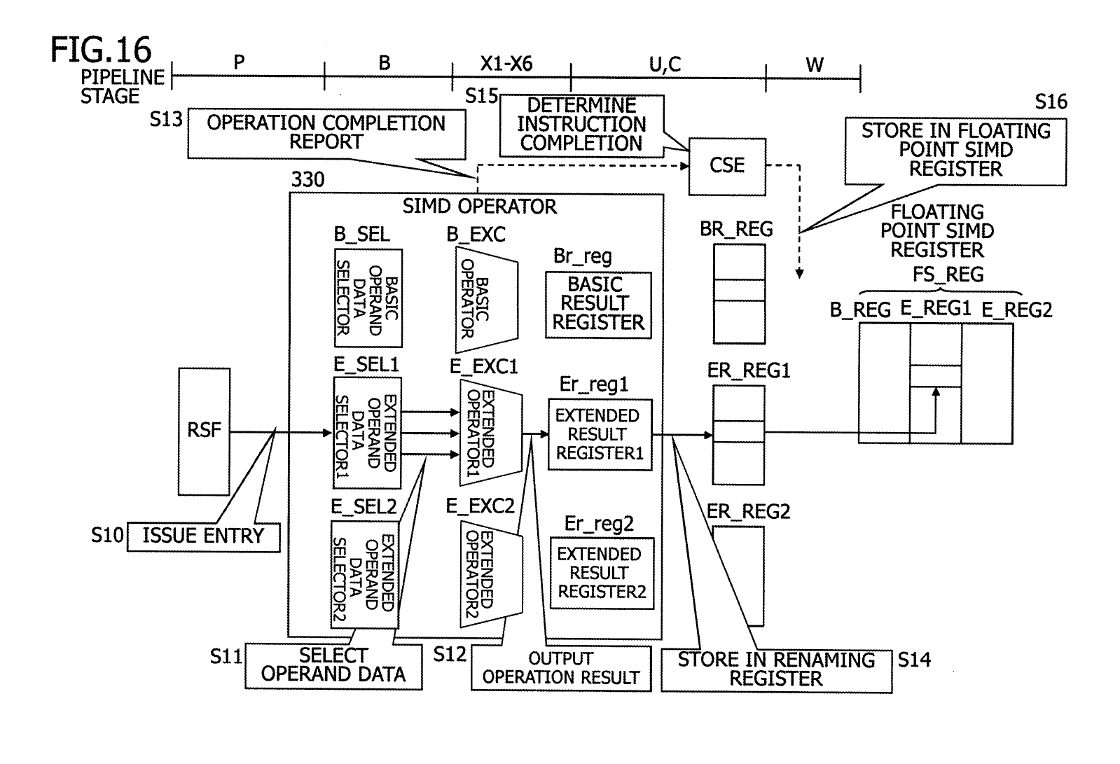

FIGS. 15 and 16 are views illustrating pipeline processing performed during execution of a non-SIMD operation instruction according to this embodiment. Respective process numbers are identical to FIGS. 13 and 14.

When a non-SIMD operation instruction is executed, the basic register B_REG or the first extended register E_REG1 of the floating point SIMD register FS_REG, and the basic renaming register BR_REG or the first extended renaming register ER_REG1 of the floating point renaming register FR_REG, allocated thereto, are used. The second extended register E_REG2 and the second extended renaming register ER_REG2 are not used. In the example of FIGS. 15 and 16, similarly to FIG. 10, the first extended register E_REG1 and the first extended renaming register ER_REG1 are used. Accordingly, associations are stored in the extended register renaming map ERRM of the register renaming unit REG_REN.

In the D cycle, the instruction decoder 305 decodes the floating point non-SIMD instruction, and on the basis of the decoding result, registers corresponding entries respectively in the commit stack entry CSE and the floating point reservation station RSF (S1, S2). Further, the instruction decoder 305 allocates a first extended renaming register ER_REG1 of the floating point renaming register FR_REG to the write destination first extended register E_REG1 of the floating point SIMD register FS_REG, and registers the association between the registers in the extended register renaming map ERRM1 of the register renaming unit REG_REN (S3). The instruction decoder 305 then registers the register number or address of the registered renaming register in an entry of the commit stack entry CSE (S4). All other processing is similar to that performed in relation to the SIMD operation instruction in FIG. 13.

In the P cycle, the floating point reservation station RSF issues the oldest entry, from among the registered entries for which the required input data are ready, to the SIMD operator 330 (S10). Next, the processing advances to FIG. 16.

In the following B cycle, the first extended operand data selector E_SEL1 selects source operand data from any of the load registers 312_B, 312_E1, 312_E2, the result registers Br_reg, Er_reg1, Er_reg2, the renaming registers BR_REG, ER_REG1, ER_REG2, and the registers B_REG, E_REG1, E_REG2, and inputs the selected data into the first extended operator E_EXC1 (S11).

In the X1 to X6 cycles, the first extended operator E_EXC1 executes operation processing on the input data selected by the operand data selector E_SEL1. The first extended operator then stores an operation result in the result register Er_reg1 (S12). Further, when having stored the operation result in the result register, the first extended operator outputs an operation completion report to the commit stack entry CSE (S13).

In the U cycle, the operation result stored in the result register Er_reg1 is stored in the corresponding first extended renaming register ER_REG1 (S14).

In the C cycle, the commit stack entry CSE determines that the SIMD operation instruction is complete on the basis of an operation report from the floating point SIMD operator 330 (S15).

Finally, in the W cycle, the commit stack entry CSE stores the operation result of the first extended renaming register ER_REG1 in the first extended register E_REG1 of the floating point SIMD register FS_REG at a timing when the current non-SIMD operation instruction is ready to completed on the basis of the instruction sequence (S16).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing unit comprising:
an instruction decoder configured to decode an instruction;
three or more operators configured to, when the instruction decoded by the instruction decoder is a multi-data instruction in which plural data processing is implemented parallel in response to a single instruction, process in parallel the plural data, and when the instruction decoded by the instruction decoder is a non-multi-data instruction in which singular data processing is implemented in response to a single instruction, process the singular data individually;
a plurality of storage destination register groups that are provided to correspond respectively to the plurality of operators and are configured to store operation results from the operators;
a plurality of renaming register groups that are provided to correspond respectively to the plurality of operators and are configured to store the operation results; and
a register renaming unit configured to store an association between a specified storage destination register specified by an instruction from the storage destination register group and an allocated renaming register allocated from the renaming register group,
wherein a register set having the storage destination register group and the renaming register group includes a basic register set used to operate the multi-data instruction and to operate the non-multi-data instruction, a first extended register set used to operate the multi-data instruction and to operate the non-multi-data instruction, and a second extended register set used to operate the multi-data instruction but not used to operate the non-multi-data instruction, and
the register renaming unit stores the association of the basic register set and the association of the first extended register set.

2. The arithmetic processing unit according to claim 1, wherein either the association of the basic register set or the association of the first extended register set is identical to the association of the second extended register set.

3. The arithmetic processing unit according to claim 2, wherein the register renaming unit includes a basic map that stores the association of the basic register set and a first extended map that stores the association of the first extended register set, but does not include a map that stores the association of the second extended register set.

4. The arithmetic processing unit according to claim 1, further comprising:
a reservation station configured to output the instruction decoded by the instruction decoder to the operator irrespective of an instruction sequence; and
a commit stack entry configured to control such that the operation result stored in the allocated renaming register is stored in the specified storage destination register corresponding to the allocated renaming register in the instruction sequence.

5. The arithmetic processing unit according to claim 1, wherein
the instruction decoder determines the association of the basic register set and the association of the first extended register set when decoding the multi-data instruction, and determines either the association of the basic register set or the association of the first extended register set when decoding the non-multi-data instruction, and
the association of the second extended register set, which is used to operate the multi-data instruction, is identical to either the association of the basic register set or the association of the first extended register set.

6. The arithmetic processing unit according to claim 1, wherein
when the multi-data instruction is operated, the plurality of operators store the operation results in the allocated renaming registers of the basic register set, the first extended register set, and the second extended register set, and
when the non-multi-data instruction is operated, any of the plurality of operators stores the operation result in the allocated renaming register of either the basic register set or the first extended register set.

7. A control method for an arithmetic processing unit including,
an instruction decoder configured to decode an instruction;
three or more operators configured to, when the instruction decoded by the instruction decoder is a multi-data instruction in which plural data processing is implemented parallel in response to a single instruction, process in parallel the plural data, and when the instruction decoded by the instruction decoder is a non-multi-data instruction in which singular data processing is implemented in response to a single instruction, process the singular data individually;
a plurality of storage destination register groups that are provided to correspond respectively to the plurality of operators and are configured to store operation results from the operators;
a plurality of renaming register groups that are provided to correspond respectively to the plurality of operators and are configured to store the operation results; and
a register renaming unit configured to store an association between a specified storage destination register specified by an instruction from the storage destination register group and an allocated renaming register allocated from the renaming register group,
the control method comprising:
using the plurality of storage destination register groups and the plurality of renaming register groups, when operating the multi-data instruction, and
using a basic storage destination register group in the plurality of storage destination register groups, a first extended storage destination register group in a plurality of extended storage destination register groups in the plurality of storage destination register groups, a basic renaming register group in the plurality of renaming register groups, and a first extended renaming register group in a plurality of extended renaming register groups in the plurality of renaming register groups, when operating the non-multi-data instruction.

8. The control method for an arithmetic processing unit according to claim 7, wherein, in operating the non-multi-data instruction, a second extended storage destination register group, which differs from the first extended storage destination register group, of the plurality of extended storage destination register groups and a second extended renaming register group, which differs from the first extended renaming register group, of the plurality of extended renaming register groups are not used.
